(19) United States
(12) Patent Application Publication
(10) Pub. No.: US 2026/0016986 A1
(43) Pub. Date: Jan. 15, 2026

(54) Controller Memory Buffer (CMB) Doorbell Synchronization

(71) Applicant: Sandisk Technologies, Inc., Milpitas, CA (US)

(72) Inventors: Shay BENISTY, Beer Sheva (IL); Amir SEGEV, Meiter (IL)

(73) Assignee: Sandisk Technologies, Inc., Milpitas, CA (US)

(21) Appl. No.: 18/770,399

(22) Filed: Jul. 11, 2024

(51) Int. Cl. G06F 3/06

(52) U.S. Cl. CPC G06F 3/0659; G06F 3/0604; G06F 3/0656; G06F 3/0679

(57) ABSTRACT

Controller memory buffer (CMB) usage is on the rise. Host devices will oftentimes place a submission queue (SQ) in CMB to take advantage of data storage device provided memory. The host device will place an entry in the SQ and ring the doorbell associated with the SQ. The controller, upon the doorbell ringing, will check the SQ. Even though the doorbell was rung, the data may not be in the SQ due to the fact that accessing the CMB is slow. To ensure the data is in the SQ, the controller can utilize two doorbells, the one that the host device rings, and a second doorbell invisible to the host device. The second doorbell is rung once the data is in the SQ. The controller then will retrieve data from the SQ only if both doorbells have been rung.

### BACKGROUND OF THE DISCLOSURE

### Field of the Disclosure

Embodiments of the present disclosure generally relate to efficient controller memory buffer (CMB) utilization.

### Description of the Related Art

Controller Memory Buffer (CMB) is a non-volatile memory (NVM) express (NVMe) solid state drive (SSD) (NVMe-SSD) feature where the data storage device holds some local memory for host device usage. Due to the CMB size, the CMB resides in a local dynamic random access memory (DRAM). The host device can use that memory for user-data on read or write commands. The host device can use CMB for physical region page (PRP)/scatter gather list (SGL) (PRP/SGL) lists, or for completion queues (CQs) and submission queues (SQs). The NVMe standard offers the following text.

The address region allocated for the CMB shall be 4 KiB aligned. It is recommended that a controller allocate the CMB on an 8 KiB boundary. The controller shall support burst transactions up to the maximum payload size, support byte enables, and arbitrary byte alignment. The host shall ensure that all writes to the CMB that are needed for a command have been sent before updating the SQ Tail doorbell property. The Memory Write Request to the SQ Tail doorbell property shall not have the Relaxed Ordering bit set to ‘1’, to ensure that prior writes to the CMB have completed.

The last sentence of the previous paragraph suggests a possible race condition between the write command and the doorbell. For the write command, the host device writes the command into the CMB initiating a write to the DRAM. For the doorbell, the host device writes a doorbell to the controller, the doorbell is observed by the controller, and the controller begins reading the command from the DRAM. If the write command is completed before the controller begins reading from DRAM, all is well. However, if the controller starts reading from DRAM before the write command completes, than the controller will read “old” data from the DRAM and not the correct data. The “Relaxed Ordering bit” protects the data until the data reaches the device peripheral component express interconnect (PCIe) boundary, but not afterwards. The doorbell and the command travel separate paths through the data storage device which leads to the race scenario.

Therefore, there is a need in the art for ensuring the data is in CMB before retrieving the data after a doorbell ringing.

### SUMMARY OF THE DISCLOSURE

Controller memory buffer (CMB) usage is on the rise. Host devices will oftentimes place a submission queue (SQ) in CMB to take advantage of data storage device provided memory. The host device will place an entry in the SQ and ring the doorbell associated with the SQ. The controller, upon the doorbell ringing, will check the SQ. Even though the doorbell was rung, the data may not be in the SQ due to the fact that accessing the CMB is slow. To ensure the data is in the SQ, the controller can utilize two doorbells, the one that the host device rings, and a second doorbell invisible to the host device. The second doorbell is rung once the data is in the SQ. The controller then will retrieve data from the SQ only if both doorbells have been rung.

In one embodiment, a data storage device comprises: a memory device; and a controller coupled to the memory device, wherein the controller is configured to: detect that a number of entries in a SQ doorbell in is greater than a number of entries in a CMB doorbell; fetch a number of commands, wherein the number of commands is equal to or less than the number of entries in the CMB doorbell; and decrease the number of entries in the SQ doorbell and the number of entries in the CMB doorbell by the number of commands fetched.

In another embodiment, a data storage device comprises: a memory device; and a controller coupled to the memory device, wherein the controller is configured to: receive an indication that a host has issued a doorbell for a SQ; determine that the SQ is managed in a CMB; choose a minimum between a number of commands written by a host device and a number of commands having a doorbell issued for the SQ; reduce the minimum from both the number of commands written by the host device and the number of commands having a doorbell issued for the SQ; and fetch commands from the SQ.

In another embodiment, a data storage device comprises: means to store data; and a controller coupled to the means to store data, wherein the controller is configured to: maintain a first doorbell corresponding to a SQ; maintain a second doorbell corresponding to a CMB; and fetch a number of commands from the CMB, wherein the number of commands is equal to or less than a number of entries in the second doorbell.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a controller with controller memory buffer (CMB).

FIG. 3A is flowchart illustrating doorbell ringing according to one embodiment.

FIG. 3B is a flowchart illustrating doorbell processing according to one embodiment.

FIG. 4 is a schematic illustration of data storage system according to one embodiment.

FIG. 5 is a flowchart illustrating data processing according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Controller memory buffer (CMB) usage is on the rise. Host devices will oftentimes place a submission queue (SQ) in CMB to take advantage of data storage device provided memory. The host device will place an entry in the SQ and ring the doorbell associated with the SQ. The controller, upon the doorbell ringing, will check the SQ. Even though the doorbell was rung, the data may not be in the SQ due to the fact that accessing the CMB is slow. To ensure the data is in the SQ, the controller can utilize two doorbells, the one that the host device rings, and a second doorbell invisible to the host device. The second doorbell is rung once the data is in the SQ. The controller then will retrieve data from the SQ only if both doorbells have been rung.

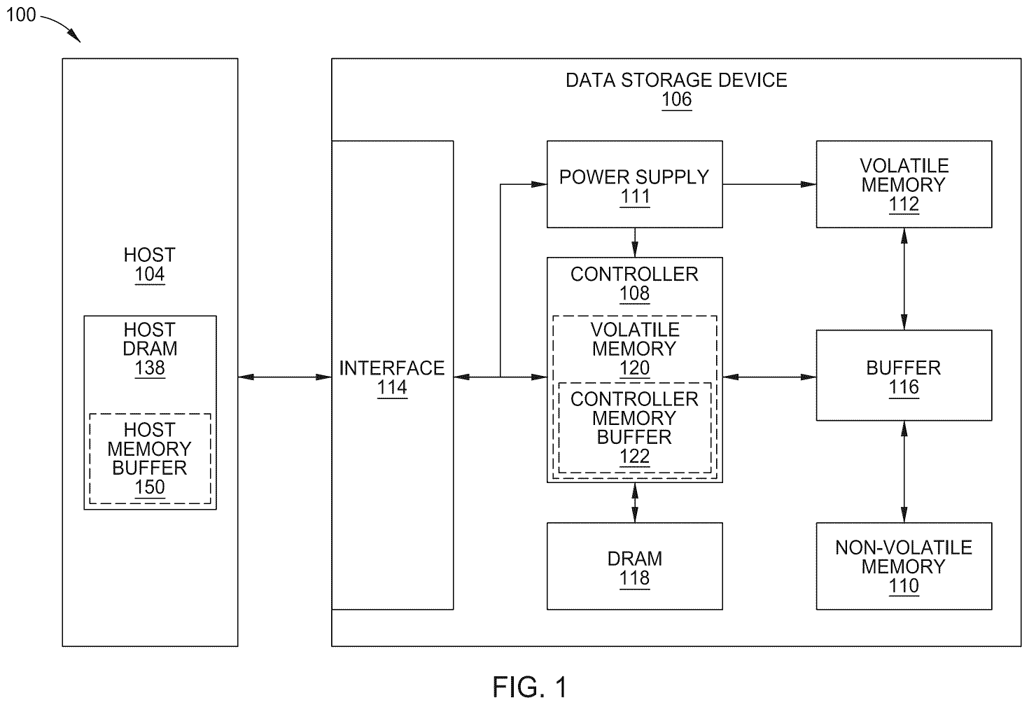

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

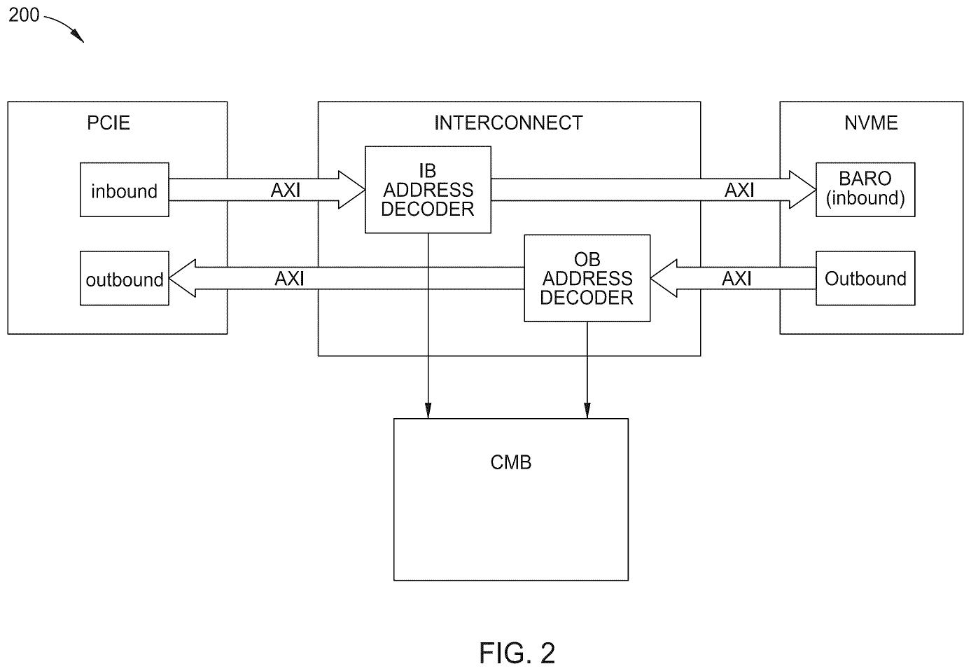

FIG. 2 is a schematic illustration of a controller 200 with CMB. The host device interacts with the PCIe of the data storage device, and the host device may write data or commands, which in FIG. 2 is the CMB. The commands sent to the CMB are sent on the inbound path. The inbound path is where the host device writes data to either CMB or to the doorbell (i.e., BARO), where the doorbell resides. Transactions coming from the host device are detected by the inbound (IB) address decoder to determine the target for the transactions, such as the CMB. Those transactions are forwarded to the CMB.

The host device may also write other transactions. For example, the doorbell for telling the data storage device that there are pending commands in one of the SQs. The doorbells are registers that are implemented in the NVMe layer. To access the registers, the inbound path is used and a determination is made at the IB address decoder that BARO is to be accessed, not CMB. So BARO transactions will be forwarded to the BARO.

The doorbell and the write commands go on separate paths, to BARO and CMB respectively. Because writing to the CMB is slow, as the CMB resides in DRAM, it is possible for the doorbell to be accepted before the data resides in the CMB, which might lead to the controller reading the data from CMB too early and thus obtaining old data.

In order to send commands to the data storage device, the host needs to write the commands to the SQ using the inbound path and then going directly to the CMB, which takes time. The host device does not really care whether the data is really written in the CMB or not. The host device just posts the write transactions and does not wait for any response from the data storage device about those transactions. The host device writes the commands to the CMB and then immediately after that rings the doorbell by accessing the BARO region.

The outbound path is the path in which the data storage device is writing or reading from the CMB or from the host device. In between the PCIe and the NVMe resides some interconnect that moves from the NVMe towards the outbound (OB) address decoder and CMB, and towards the PCIe.

There might be a scenario when the host device writes the commands again. Writing commands again will take time and if the writing occurs immediately after ringing the doorbell, there might be a scenario that the doorbell transactions would be accepted by the NVMe layer before the data is written to the CMB. In such a scenario, the data storage device will try to access the CMB and will obtain the incorrect data. The scenario is a valid race scenario that may happen if the CMB is in DRAM and the BARO is in registers.

One approach to solve the race scenario is to make sure the CMB-write-pipe is clear before executing a command fetching due to the doorbell, but there would be a latency penalty. When the doorbell is rung, the write path needs to be flushed to make sure the write pipe is empty so that all previous transactions that were issued by the host device are really completed. In the approach, there is a read performance problem because each and every read transaction will need to flush the write pipe which will take time and hence increase the latency.

A double doorbell, as discussed herein, would be beneficial. When using a double doorbell, the controller will only fetch the command if both a host issued doorbell has occurred and the command has been written to the DRAM. The host device will not be aware of the additional doorbell. An example for using the additional doorbell will be described next.

Initially, the host device writes the commands to the CMB and then the host device issues the doorbell. The additional doorbell is triggered by the CMB. The CMB rings the additional doorbell after the data or the commands are written to the DRAM. In the scenario, the data storage device will not start fetching commands from the CMB unless both doorbells are rung. The first doorbell is the one the host device rings. The other doorbell will indicate that the data is available in the CMB. The NVMe layer will not access the commands that are stored in the CMB unless and the two doorbell registers indicate that the data is valid or the commands are pending in the CMB and are ready for fetching. By adding the additional doorbell there is confirmation that the commands are really stored in the CMB.

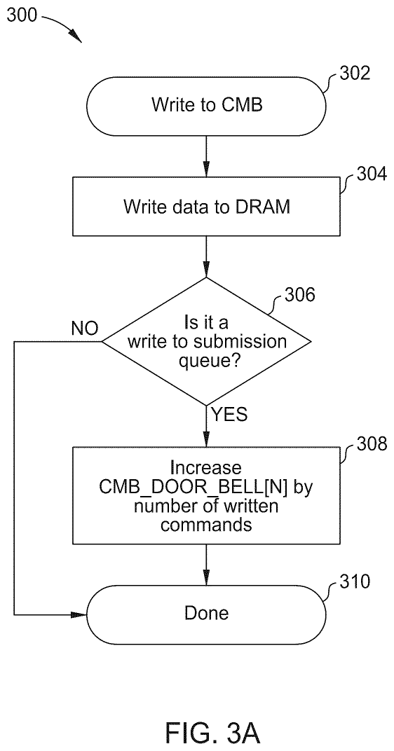

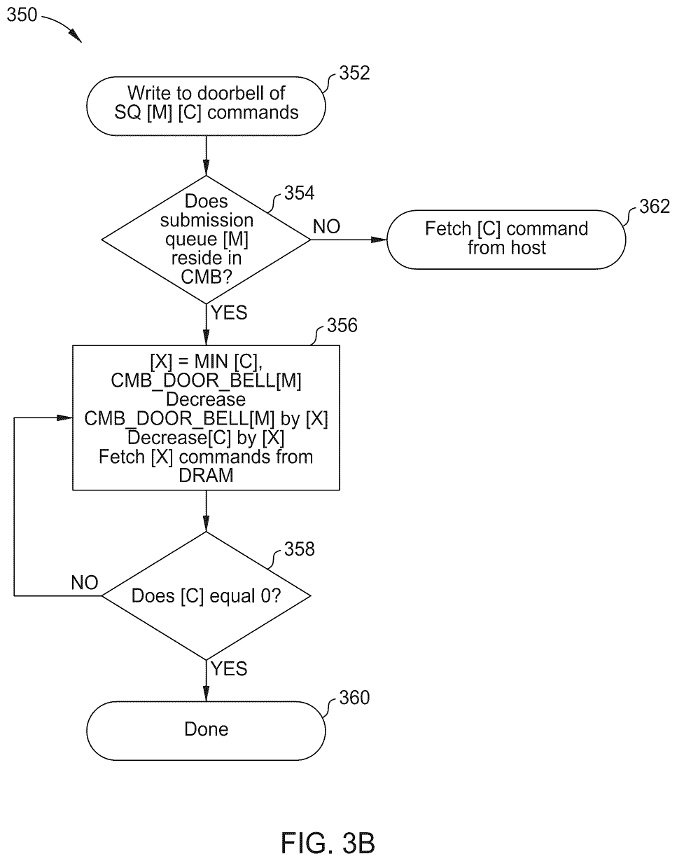

FIG. 3A is flowchart 300 illustrating doorbell ringing according to one embodiment. When the host writes to CMB, the data is written to the DRAM. If the write was of a command entry (or multiple of) into a SQ, a counter “CMB_DOOR_BELL” of that specific SQ is increased accordingly. In FIG. 3A, the host device initially sends a command to write data to CMB at block 302 and the data is written to DRAM in block 304. A determination is made at block 306 regarding whether the write command is to a SQ. If yes, then CMB_DOOR_BELL[N] is increased by the number of write commands at 308. If no, then the process is done at block 310. Regardless, if writing to a SQ at block 306, the process is done at block 310 after increasing the CMB_DOOR_BELL[N] at block 308.

FIG. 3B is a flowchart 350 illustrating doorbell processing according to one embodiment. The flow starts when the host issues a doorbell to submission queue [M] asking the controller to fetch a command (or [C] commands) at block 352. First the controller checks if the SQ [M] is managed in the CMB or in the host DRAM at block 354. If the SQ is not managed in the DRAM, the data storage device fetches commands from the host at block 362, and the flow completes. If SQ [M] is managed in the CMB, the data storage device does the following: Choose the minimum between (and call it [X]: Number of commands written by host (from FIG. 3A: CMB_DOOR_BELL[M]); Number of commands [C] were doorbelled for submission queue [M]; Reduce the minimum found [X] from both values: ([C] and CMB_DOOR_BELL[M]); Fetch [X] commands at block 356. If the host device requested to fetch more commands ([C]>0) than were available when a fetch was done at block 358, the process is repeated at block 356 until all commands have been written to DRAM (FIG. 3A) and fetched by controller. Otherwise, the process ends as block 360.

Considering FIGS. 3A and 3B together, after receiving the initial command to write data, the data storage device detects whether the write command is to write to a SQ in CMB or not. If not writing to a SQ, then nothing special is done. If writing to SQ, then the write command is available and the data storage device can go ahead and fetch the write command. But if the write command resides in the CMB, even though the doorbell from the host device indicates the command is available, the command will not be fetched. Instead, the data storage device waits for the second doorbell. Only when the second doorbell transaction occurs will the write command be fetched. Instead of having a single doorbell indication that is coming from the host device, there is the additional doorbell indication created in the controller. The second doorbell indication is not coming from the host device. The additional doorbell is implemented internally in the data storage device to make sure that the write command is really in DRAM.

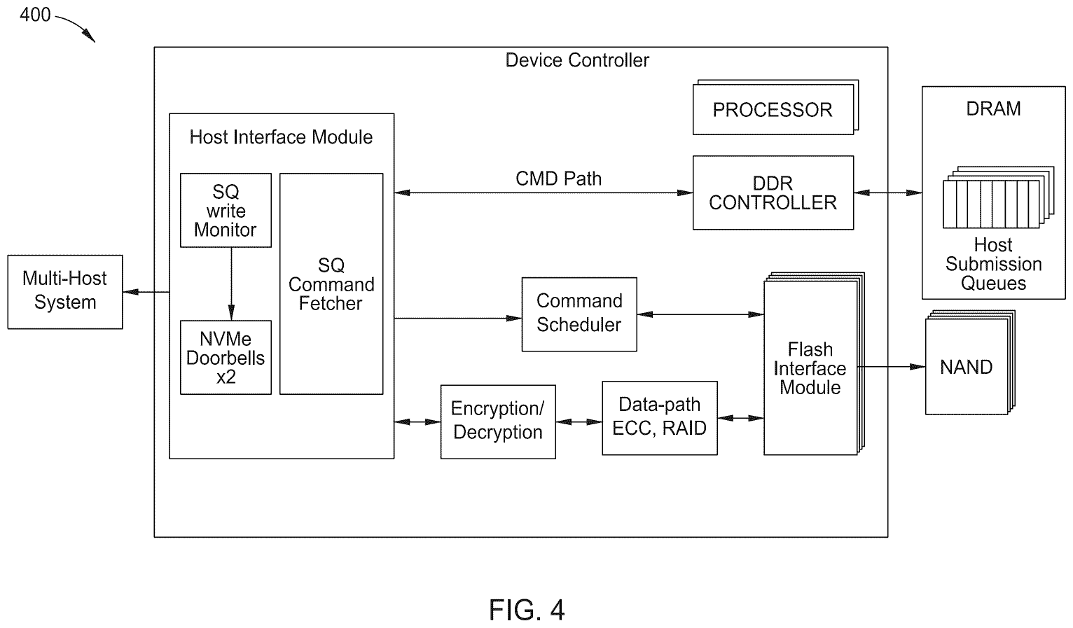

FIG. 4 is a schematic illustration 400 of data storage system according to one embodiment. FIG. 4 includes a device controller having a host interface module (HIM) that includes a SQ write monitor, a SQ command fetcher, and two NVMe doorbells. The device controller also includes a plurality of processors and a DDR controller for the volatile memory (i.e., DRAM) which in FIG. 4 contains SQs in CMB. A flash interface module (FIM) is present for each flash (e.g., NAND) module. A command scheduler, encryption/decryption module, and data path comprising ECC and RAID is also present.

The SQ Write Monitor is the engine that is responsible for monitoring the write accesses towards the SQs implemented in CMB DRAM. When the host device writes a new command, a new doorbell register is updated. The NVMe Doorbell x 2 is the engine that implements two doorbell registers per SQ. For each and every SQ implemented in CMB, there will be two doorbells, one doorbell for the host device and one doorbell for internal usage. The first doorbell register is the one that is defined in NVMe standard while the second doorbell register is based on write and read accesses of the relevant SQ. Write transactions are issued by the host device while read transactions are issued by the device controller. The SQ Command Fetcher is the engine that is responsible for the command fetching but the fetching is done only when both doorbell registers indicate that a command is pending in the relevant SQ.

The SQL Write Monitor is used to monitor whether the host device is writing commands to the SQs that are implemented in CMB. Detection of the write location is needed to ensure the second doorbell register is used to make sure the data storage device waits for two doorbell indications before fetching from the CMB.

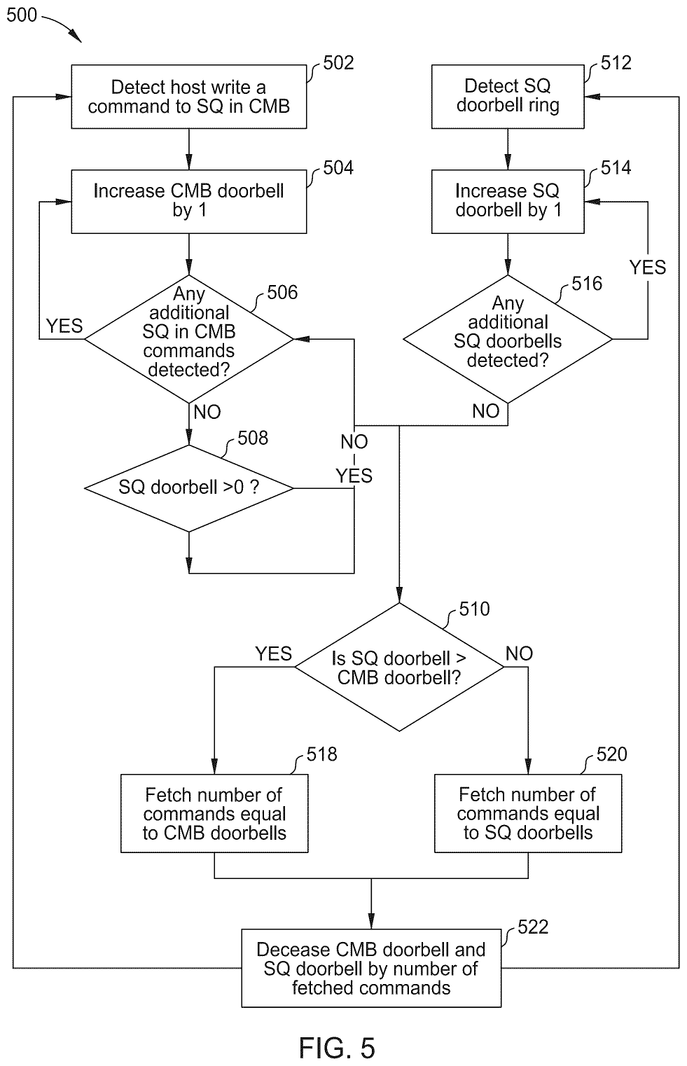

FIG. 5 is a flowchart 500 illustrating data processing according to one embodiment. Initially, the data storage device detects that a host device has written a command to a SQ that is located in CMB at block 502. The CMB doorbell is thus increased by 1 at block 504. A determination is made at block 506 regarding whether there are any additional CMB commands detected. If there are more CMB commands, then the process repeats at block 504, but if there are no additional CMB commands, then a determination is made at block 508 regarding whether the SQ doorbell is greater than 0. If the SQ doorbell is not greater than 0, then the process repeats at block 506. If the SQ doorbell is greater than 0, then a determination is made regarding whether the SQ doorbell is greater than the CMB doorbell at block 510.

The SQ doorbell ringing is detected at block 512 and the SQ doorbell is increased by 1 at block 514. A determination is made at block 516 regarding whether there are any additional doorbells detected. If yes, then the process repeats as block 514. If no, then the process moves to block 510.

At block 510, a determination is made regarding whether the SQ doorbell is greater than the CMB doorbell, numerically. If the SQ doorbell is greater than the CMB doorbell, then the data storage device may fetch only the number of commands that equal to the number of CMB doorbells at block 518 and then decrease the CMB doorbell and SQ doorbell by the number of fetched commands at block 522. If the SQ doorbell is not greater than the CMB doorbell at block 510, then the data storage device fetches the number of commands that is equal to the SQ doorbells at block 520 and then proceeds to block 522. After block 522, the process repeats at blocks 502 and 512.

By tracking how many commands per SQ in the CMB were posted by the host device, and how many were triggered doorbells, the data storage device can fetch commands without risking the race condition. The doorbell will not back-pressure the CMB writes, and thus will not cause bandwidth degradation.

In one embodiment, a data storage device comprises: a memory device; and a controller coupled to the memory device, wherein the controller is configured to: detect that a number of entries in a SQ doorbell in is greater than a number of entries in a CMB doorbell; fetch a number of commands, wherein the number of commands is equal to or less than the number of entries in the CMB doorbell; and decrease the number of entries in the SQ doorbell and the number of entries in the CMB doorbell by the number of commands fetched. The controller is further configured to increase the number of entries in the CMB doorbell by 1 each time a new command is written to the CMB. The controller is further configured to increase the number of entries in the SQ doorbell by 1 each time a new doorbell is written to a SQ doorbell register. The controller is configured to determine whether a SQ resides in CMB. The controller is configured to not fetch a number of commands that is greater than the number of entries in the CMB doorbell. The controller includes a host interface module (HIM) that includes a SQ write monitor, a SQ command fetcher, and two NVMe doorbells. The two NVMe doorbells comprise the SQ doorbell and the CMB doorbell. The SQ write monitor is configured to monitor write access towards SQs implemented in CMB. When a host device writes a new command, an entry is made in the CMB doorbell. The SQ command fetcher is configured to fetch commands when both doorbells indicate that a command is pending in a relevant SQ.

In another embodiment, a data storage device comprises: a memory device; and a controller coupled to the memory device, wherein the controller is configured to: receive an indication that a host has issued a doorbell for a SQ; determine that the SQ is managed in a CMB; choose a minimum between a number of commands written by a host device and a number of commands having a doorbell issued for the SQ; reduce the minimum from both the number of commands written by the host device and the number of commands having a doorbell issued for the SQ; and fetch commands from the SQ. A number of commands fetched is equal to the minimum. The number of command written by the host device is equal to a number of command doorbells. The controller is further configured to maintain two doorbells. One doorbell of the two doorbells is for the number of commands written by the host device. A second doorbell of the two doorbells is for the number of commands doorbelled for the SQ by the host device. One doorbell of the two doorbells is defined in an NVMe standard and a second doorbell of the two doorbells is based on write and read accesses of the SQ.

In another embodiment, a data storage device comprises: means to store data; and a controller coupled to the means to store data, wherein the controller is configured to: maintain a first doorbell corresponding to a SQ; maintain a second doorbell corresponding to a CMB; and fetch a number of commands from the CMB, wherein the number of commands is equal to or less than a number of entries in the second doorbell. The SQ is disposed in the CMB. The controller is configured to monitor write access towards the SQ.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
detect that a number of entries in a submission queue (SQ) doorbell in is greater than a number of entries in a controller memory buffer (CMB) doorbell;
fetch a number of commands, wherein the number of commands is equal to or less than the number of entries in the CMB doorbell; and
decrease the number of entries in the SQ doorbell and the number of entries in the CMB doorbell by the number of commands fetched.

2. The data storage device of claim 1, wherein the controller is further configured to increase the number of entries in the CMB doorbell by 1 each time a new command is written to the CMB.

3. The data storage device of claim 1, wherein the controller is further configured to increase the number of entries in the SQ doorbell by 1 each time a new doorbell is written to a SQ doorbell register.

4. The data storage device of claim 1, wherein the controller is configured to determine whether a SQ resides in CMB.

5. The data storage device of claim 1, wherein the controller is configured to not fetch a number of commands that is greater than the number of entries in the CMB doorbell.

6. The data storage device of claim 1, wherein the controller includes a host interface module (HIM) that includes a SQ write monitor, a SQ command fetcher, and two non-volatile memory express (NVMe) doorbells.

7. The data storage device of claim 6, wherein the two NVMe doorbells comprise the SQ doorbell and the CMB doorbell.

8. The data storage device of claim 6, wherein the SQ write monitor is configured to monitor write access towards SQs implemented in CMB.

9. The data storage device of claim 8, wherein when a host device writes a new command, an entry is made in the CMB doorbell.

10. The data storage device of claim 6, wherein the SQ command fetcher is configured to fetch commands when both doorbells indicate that a command is pending in a relevant SQ.

11. A data storage device, comprising:
a memory device; and
a controller coupled to the memory device, wherein the controller is configured to:
receive an indication that a host has issued a doorbell for a submission queue (SQ);
determine that the SQ is managed in a controller memory buffer (CMB);
choose a minimum between a number of commands written by a host device and a number of commands having a doorbell issued for the SQ;
reduce the minimum from both the number of commands written by the host device and the number of commands having a doorbell issued for the SQ; and
fetch commands from the SQ.

12. The data storage device of claim 11, wherein a number of commands fetched is equal to the minimum.

13. The data storage device of claim 11, wherein the number of command written by the host device is equal to a number of command doorbells.

14. The data storage device of claim 11, wherein the controller is further configured to maintain two doorbells.

15. The data storage device of claim 14, wherein one doorbell of the two doorbells is for the number of commands written by the host device.

16. The data storage device of claim 15, wherein a second doorbell of the two doorbells is for the number of commands doorbelled for the SQ by the host device.

17. The data storage device of claim 14, wherein one doorbell of the two doorbells is defined in a non-volatile memory express (NVMe) standard and a second doorbell of the two doorbells is based on write and read accesses of the SQ.

18. A data storage device, comprising:
means to store data; and
a controller coupled to the means to store data, wherein the controller is configured to:
maintain a first doorbell corresponding to a submission queue (SQ);
maintain a second doorbell corresponding to a controller memory buffer (CMB); and
fetch a number of commands from the CMB, wherein the number of commands is equal to or less than a number of entries in the second doorbell.

19. The data storage device of claim 18, wherein the SQ is disposed in the CMB.

20. The data storage device of claim 18, wherein the controller is configured to monitor write access towards the SQ.
